(19) United States
(12) Patent Application Publication
(10) Pub. No.: US 2011/0078958 A1
(43) Pub. Date: Apr. 7, 2011

(54) MOTORIZED HOPPER DOOR ACTUATION SYSTEM

(75) Inventors: Steven James Knight, Mission Hill, SD (US); James Edward Elsen, Yankton, SD (US)

(73) Assignee: SHUR COMPANY, Yankton, SD (US)

(21) Appl. No.: 12/573,974

(22) Filed: Oct. 6, 2009

(51) Int. Cl. E05F 15/18; E05F 15/00

(52) U.S. Cl. 49/357; 49/324

(57) ABSTRACT

A motorized hopper door actuation system for use in conjunction with a hopper vehicle having at least one hopper door for removing product therefrom. The motorized hopper door actuation system includes a motor, mounting mechanism and control mechanism. The motor is operatively attached to the hopper door. The mounting mechanism is operatively attached to the hopper vehicle. The control means is operably attached to the motor.

### FIELD OF THE INVENTION

The invention generally relates to an actuator system. More particularly, the invention relates to a motorized hopper door actuation system.

### BACKGROUND OF THE INVENTION

Various commodities such as grain, fertilizer and sand are transported in bulk in hopper-style vehicles. These hopper-style vehicles may take a variety of configurations depending on the intended use. Examples of the hopper-style vehicles are trailers and railroad cars.

The commodities are typically placed into the hopper-style vehicles through an open upper portion. One configuration for removing the commodities is through trap doors that are mounted in a lower surface of the hopper. Two primary configurations for the trap doors are sliding and pivoting.

The sliding trap doors are typically operated by manually turning a crank handle connected to a drive shaft that engages the trap door and causes the trap door to slide between the open and closed positions. Depending on a variety of factors such as the size of the trap door, the shape of the trap door and the weight of the product stored in the hopper-style vehicle, the force required to actuate the trap door may be greater than certain operators can easily produce by hand.

In some cases, motors have been used to turn the drive shaft. When a motor unit is used, it is desirable that the motor unit may be quickly and easily installed. It is also desirable that the motor unit can be easily serviced without significant interruption in the ability to use the trailer on which the motor unit is installed if a motor failure occurs.

A prior art hopper door motor system is marketed by Roll Rite, LLC, of Alger, Mich. During installation the manual drive system is detached from the trailer, modified to attach the motor and then reinstalled on the trailer. Thereafter, limit switches are attached at locations around the hopper door and a remote mounted electronic control box must be connected to operate the system. A guard is also typically attached to the modified drive system to protect the motor from damage. A drawback of this system is that extensive labor is required to install and service the system, which necessitates removing the trailer from service and increasing the cost of installation.

### SUMMARY OF THE INVENTION

The present invention overcomes the shortcomings of the prior art motorized hopper door actuation systems by providing a simplified design with the drive motor, motor control circuit, power connections and a drive shaft for manual operation integrated into the actuator system. With these functions integrated into one assembly, installation time is greatly reduced.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a front view of a motorized hopper door actuation system according to an embodiment of the invention.

FIG. 2 is a rear view of the motorized hopper door actuation system.

FIG. 3 is a side view of the motorized hopper door actuation system.

FIG. 4 is a perspective view of the motorized hopper door actuation system attached to a trailer.

FIG. 5 is a perspective view of the motorized hopper door actuation system with a handle attached hereto for manual operation.

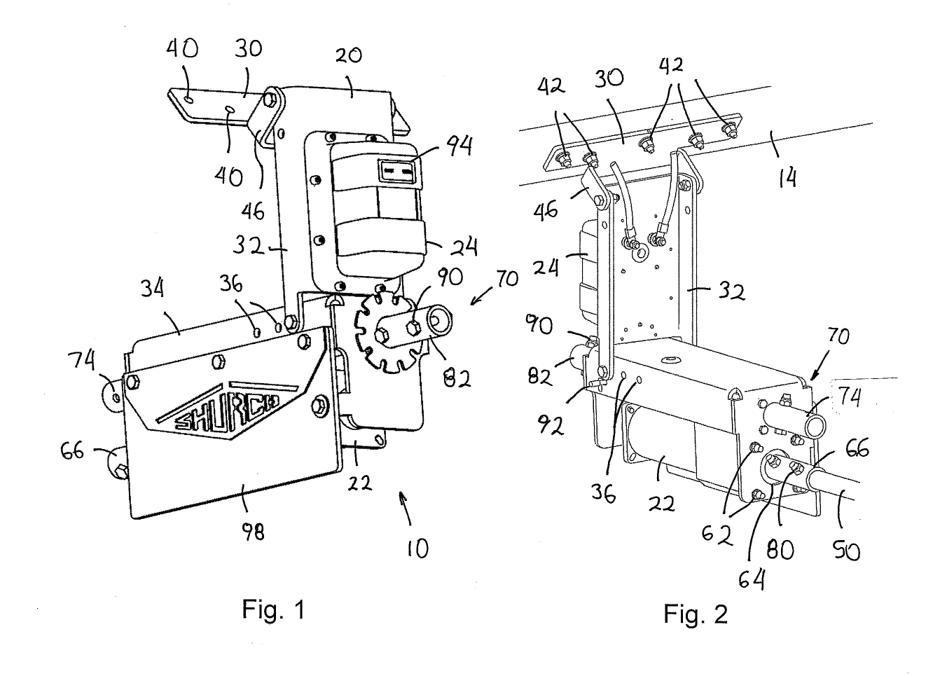

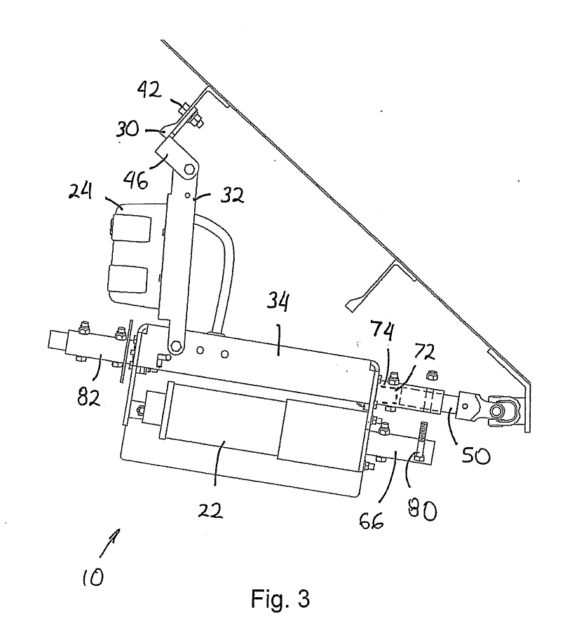

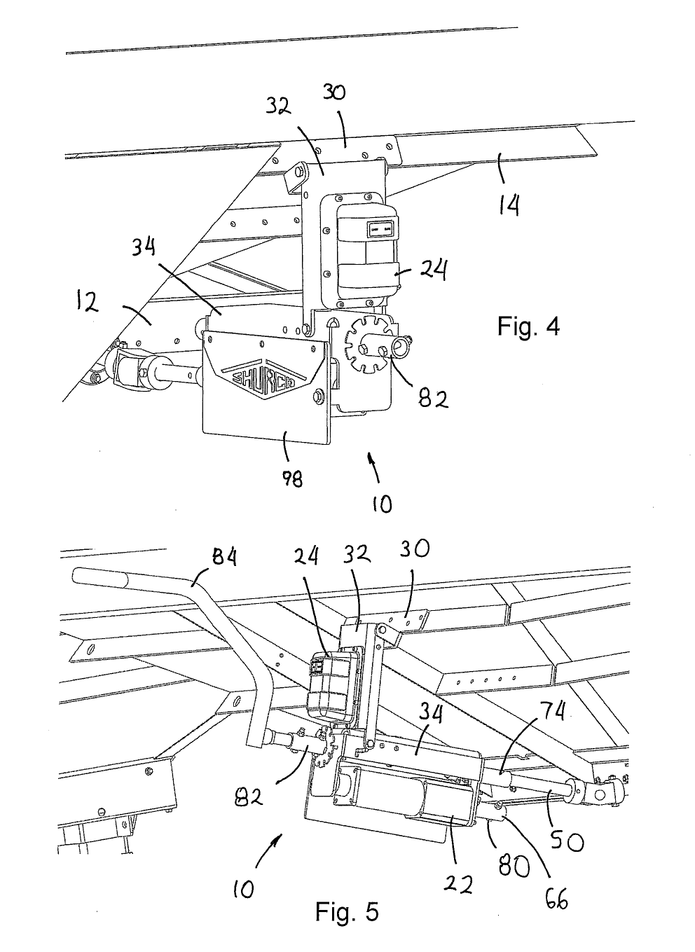

### DETAILED DESCRIPTION OF THE PREFERRED EMBODIMENTS

An embodiment of the invention is directed to a motorized hopper door actuation system, as illustrated at 10 in the figures. The motorized hopper door actuation system 10 is attached to a hopper door 12 on a trailer 14. The motorized hopper door actuation system 10 may be readily attached to the trailer 14 with minimal reconfiguration of the trailer 14. While the motorized hopper door actuation system 10 is described herein with respect to use in conjunction with a trailer 14, a person of skill in the art will appreciate that it is possible to adapt the concepts of the invention for use in conjunction with other hopper-style vehicles.

The motorized hopper door actuation system 10 may generally include a mounting structure 20, a drive motor 22 and a control module 24. The mounting structure 20 attaches the drive motor and the control module 24 to the trailer 14 in engagement with the hopper door 12.

The mounting structure 20 may include a mounting section 30, an arm section 32 and a main section 34 that are operably attached to each other. In certain embodiments, the mounting section 30 may be pivotally attached to the main section 34 with the arm section 32.

Pivotally attaching these components enables the motorized hopper door actuation system 10 to be used in conjunction with trailers 14 having a variety of configurations. Pivotally attaching these components also enables the motorized hopper door actuation system 10 to be readily moved between motorized and manual configurations, as is described in more detail herein.

The mounting section 30 is configured for use in attaching the motorized hopper door actuation system 10 to the trailer 14. The mounting section 30 may be fabricated from a variety of materials that are selected to provide the mounting section 30 with sufficient structural rigidity such that the mounting section 30 resists deformation when used. A non-limiting example of a suitable material for use in fabricating the mounting section 30 is a metal sheet having a thickness of about ¼ of an inch. In certain embodiments, a corrosion resistance material may be applied to the metal sheet.

The mounting section 30 may have a plurality of apertures 40 formed therein that are each adapted to receive bolts 42. The apertures 40 may be configured to generally conform to aperture patterns that are used for attaching manual gear boxes to trailers. Configuring the mounting section 30 in this manner enables the motorized hopper door actuation system 10 to be attached to the trailer 14 without forming any additional apertures in the trailer 14.

Using bolts 42 to attach the motorized hopper door actuation system 10 to the trailer enables the motorized hopper door actuation system 10 to be rapidly attached to the trailer 14 during the initial installation as well as to be rapidly detached from the trailer 14 for performing maintenance on the motorized hopper door actuation system 10.

A person of skill in the art will appreciate that alternate techniques may be used to attach the motorized hopper door actuation system 10 to the trailer 14. Non-limiting examples of the alternate mounting techniques include clamping and welding.

The arm section 32 may be pivotally attached to at least one arm 46 that extends from the mounting section 30. The arm section 32 may be selected with a length that enables the main section 34 to be generally aligned to a hopper drive shaft 50. To enhance the strength of the arm section 32, the arm section 32 may be formed with a generally U-shaped configuration.

Similar to the mounting section 30, the arm section 32 may be fabricated from a variety of materials that are selected to provide the arm section 32 with sufficient structural rigidity such that the arm section 32 resists deformation when used. A non-limiting example of a suitable material for use in fabricating the arm section 32 is a metal sheet having a thickness of about ¼ of an inch. In certain embodiments, a corrosion resistance material may be applied to the metal sheet.

The main section 34 may be pivotally attached to an end of the arm section 32 that is opposite the mounting section 30. The main section 34 may include more than one aperture 36 at which the arm section 32 is attached to the main section 34. Fabricating the main section 34 in this manner enables the motorized hopper door actuation system 10 to be configured for use with a large variety of trailers 14.

The main section 34 may be selected with a width that generally conforms to a length and a width of a drive motor 22. In addition to facilitating mounting of the drive motor 22 in the motorized hopper door actuation system 10, the main section 34 may extend at least partially over at least a side of the drive motor 22 to protect the drive motor 22 from damage as the trailer 14 to which the motorized hopper door actuation system 10 moves along a road or other surface.

The main section 34 may be fabricated from a variety of materials that are selected to provide the main section 34 with sufficient structural rigidity such that the main section 34 resists deformation when used. For example, the main section 34 should resist deformation when the motor 22 operates under stall conditions. A non-limiting example of a suitable material for use in fabricating the main section 34 is a metal sheet having a thickness of about ¼ of an inch. In certain embodiments, a corrosion resistance material may be applied to the metal sheet.

The drive motor 22 may be removably attached to the main section 34 such as by using a plurality of bolts 62. The main section 34 may include an aperture 64 in an end thereof through which a motor output coupler 66 may extend. The motor output coupler 66 is operably attached to the drive motor 22.

A manual drive system 70 may also be mounted to the main section 34. The manual drive system 70 enables the motorized hopper door actuation system 10 to be used when power is not available for the drive motor 22 or when there is a malfunction in the drive motor 22.

The manual drive system 70 also enables the hopper door 12 to continue to be operated when the drive motor 22 is detached from the other components of the motorized hopper door actuation system 10, which allows the trailer 14 to continue to be used while the drive motor 22 is being serviced.

The manual drive system 70 may generally include a shaft 72 that is formed with a length that is greater than a length of the main section 34. The shaft 72 is mounted for rotational motion with respect to the main section 34 about a central axis of the shaft 72. Depending on the anticipated force needed to rotate the shaft 72, at least one bearing may be provided to attach the shaft 72 to the main section 34.

Depending on the force that needs to be applied to move the hopper door 12 between the open and closed positions, the manual drive system 70 may include a plurality of gears that engage each other to thereby reduce the amount of force needed to rotate the shaft 72.

A manual drive output coupler 74 may be provided at a first end of the shaft 72 for attaching the shaft 72 to the hopper drive shaft 50. A person of skill in the art will appreciate that a variety of techniques may be used for attaching the manual drive output coupler 74 to the hopper drive shaft 50.

In one configuration, an end of the hopper drive shaft 50 is cut off and then attached to the manual drive output coupler 74. The cut off portion of the hopper drive shaft may be attached to the motorized hopper door actuation system 10 using the manual drive input coupler 82. Configuring the system in this manner enables the crank handle 84 that was previously used to operate the hopper door 12 to be used in conjunction with the motorized hopper door actuator system 10.

A non-limiting example of one such attachment technique is forming the hopper drive shaft 50 with a generally cylindrical outer surface having a first diameter. The manual drive output coupler 74 may be formed with cylindrical recess 78 having a second diameter that is slightly larger than the first diameter. Using this configuration enables the hopper drive shaft 50 to be extended into the manual drive output coupler 74.

A fastener such as a bolt 80 may be extended through apertures in the manual drive output coupler 74 and the hopper drive shaft 50 to retain the hopper drive shaft 50 in a stationary position with respect to the manual drive output coupler 74.

A manual drive input coupler 82 may be attached to a second end of the shaft 72 for attachment to a handle 84. A person of skill in the art will appreciate that a variety of techniques may be used for attaching the manual drive input coupler 82 to the handle 84. A non-limiting example of one such attachment technique is forming the handle 84 with a generally cylindrical outer surface having a first diameter. The manual drive input coupler 82 may be formed with cylindrical recess 88 having a second diameter that is slightly larger than the first diameter. Using this configuration enables the handle 84 to be extended into the manual drive input coupler 82.

A fastener such as a bolt 90 may be extended through apertures in the manual drive input coupler 82 and the handle 84 to retain the handle 84 in a stationary position with respect to the manual drive input coupler 82.

A manual drive locking mechanism 92 may be provided on the motorized hopper door actuation system 10. The manual drive locking mechanism 92 may be a pin that is oriented generally parallel to the shaft 72. The manual drive locking mechanism 92 is movable between an engaged position and a disengaged position. When the manual drive locking mechanism 92 is in the engaged position, the manual drive locking mechanism 92 may engage a slotted wheel attached to the coupler and thereby prevent the shaft 72 from rotating. The manual drive locking mechanism 92 thereby prevents inadvertent opening of the hopper door caused by rotation of the shaft 72. When it is desired to manually open the hopper door 12, the manual drive locking mechanism 92 is moved to the disengaged position to allow the shaft 72 to rotate.

The drive motor 22 may have a variety of sizes depending on the force needed to move the hopper door 12 between the closed and opened positions. In certain embodiments, the drive motor 22 may be electrically or hydraulically operated.

The motor 22 may be formed with a sufficient strength to resist damage to the components inside of the motor 22, such as armature and gears, when subjected to intermittent stalls in which power is provided to the motor 22 and the motor 22 is prevented from rotating. Stalling occurs when the hopper door 12 reaches an end of its operable range and power continues to be provided to the motor 22 such as when the operator does not realize that the hopper door 12 has reached the end of its operable range.

In certain embodiments, the motor 22 may resist damage when stalled for a period of up to about 2 minutes. One such feature of the motor 22 that enables the motor 22 to withstand damage during a stall is that the wiring in the armature has a long thermal constant.

When the drive motor 22 is electrically operated, it may have a strength of up to about 500 foot-pounds. In certain embodiments, the drive motor 22 has a strength of between about 200 and 300 foot-pounds. In other embodiments, the drive motor 22 has a strength of about 250 foot-pounds.

The drive motor 22 may include a braking mechanism that prevents inadvertent rotation of the motor output coupler 66. The braking mechanism may automatically engage when power to the drive motor 22 is turned off.

To protect the drive motor 22 as well as the other components on the trailer 14, the motorized hopper door actuation system 10 may include a circuit breaker (not shown). In certain embodiments, the circuit breaker may have a rating of up to about 100 amps. In other embodiments, the circuit breaker may have a rating of about 80 amps. In still other embodiments, the circuit breaker may have a rating of between about 20 amps and about 50 amps. Alternatively or additionally, electronic current limiting systems may be used in conjunction with the motorized hopper door actuation system 10.

The drive motor 22 may be connected to the control module 24 that controls power to the drive motor 22 and thereby controls the operation of the drive motor 22. The control module 24 may be mounted on the arm section 22. Mounting the control module 24 in this manner not only reduces the time to attach the motorized hopper door actuation system 10 to the trailer 14 but also reduces the number of holes that must be formed in the trailer 14.

The control module 24 may include a switching mechanism 94 that controls delivery of electrical current to the drive motor 22. In certain embodiments, the switching mechanism 94 may be a single button. When the button is activated, the control module 24 may be turned on. When the button is activated again, the control module 24 may be turned off.

In an alternative embodiment where the drive motor 22 is a hydraulic motor, the switching mechanism 94 controls the delivery of hydraulic fluid to the drive motor 22. Depending on the configuration of the control module 24, the control module 24 may include electric relays and/or solenoids.

The control module 24 may include circuitry that monitors the amount of time that the drive motor 22 has been activated such that the drive motor 22 does not attempt to move the hopper door 12 beyond the operational path of the hopper door 12, which could cause damage to the hopper door 12 and/or the components of the motorized hopper door actuation system 10. The motorized hopper door actuation system 10 thereby does not require limit switches to be attached to the trailer 14.

The control module 24 may include a substantially sealed outer enclosure that protects the components from physical damage or damage caused by contact with materials such as moisture.

The control module 24 includes at least one power connection 96. The power connection 96 may take a variety of forms that are manually operable or operable using a tool. One such suitable configuration for the power connection 96 is a nut that engages a threaded post extending from the control module 24.

The power connection 96 thereby enables connection and disconnection of wires 98 without having to open the control module 24. To protect the power connection 96 from damage, the power connection 96 may be placed on a back side of the arm section 22.

The control module 24 may be programmed to automatically turn off after a selected period of time of inactivity. In certain embodiments, the control module 24 may be programmed to turn off after 5 minutes of inactivity.

While it is possible to control the operation of the motorized hopper door actuation system 10 by physically touching the switching mechanism 94, it is also possible to provide either wired or wireless connection between the control module 24 and a remote control that is located inside of the cab. The remote control thereby enables the hopper door 12 to be opened and closed without the operator leaving the cab. In addition to controlling the motorized hopper door actuation system 10, it is possible for the remote control to also activate and deactivate other components on the trailer or cab such as a covering system that extends over an upper surface of the trailer.

The motorized hopper door actuation system 10 may provide an insulated mounting of the electrical components contained therein. Using a dielectric insulator between the mounting bracket and the trailer prevents galvanic corrosion between the trailer and the motorized hopper door actuation system 10.

To provide further protection to the components in the motorized hopper door actuation system 10, it is possible to mount a mud flap 98 to a side of the main section 24. The mud flap 98 also prevents external elements such as rain and mud from coming into contact with the drive motor 22 or other components inside of the main section 24.

The mud flap 98 may be fabricated from a durable material that resists breaking from contact by external objects as the trailer is moving to thereby prevent such objects from contacting the drive motor 22.

The mud flap 98 may be formed with a length that is approximately the same as a length of the main section 24. The mud flap 98 may be formed with a height that is greater than a height of the main section 24 such that the mud flap 98 extends below a lower surface of the main section 24.

In operation, if used on the trailer, a gear box (not shown) is detached from the hopper drive shaft 50. Prior to attaching the motorized hopper door actuation system 10, it may be necessary to shorten the hopper drive shaft 50 so that the motorized hopper door actuation system 10 may be located as close as possible to the surface of the trailer 14.

Next, the motor output coupler 66 is aligned with the hopper drive shaft 50 and a bolt 80 is extended through both the hopper drive shaft 50 and the motor output coupler 66 to attach these two components together. Alternatively, these components may be attached together after the mounting section 30 is attached to the trailer 14.

The mounting section 30 is attached to the trailer 14. As indicated above, bolts may be used to attach the mounting section 30 to the trailer 14 because the bolts enable the motorized hopper door actuation system 10 to be detached from the trailer 14.

The power connections 96 are attached to a power source either on the trailer 14 or the cab attached thereto. The hopper door 12 may be operated by using the control module 24 either directly or using the remote control.

If desired to operate the motorized hopper door actuation system 10 in the manual mode, the hopper drive shaft 50 is detached from the motor output coupler 66 and at least one of the motorized hopper door actuation system 10 and the hopper drive shaft 50 is shifted so that the hopper drive shaft 50 is aligned with the manual drive output coupler 74 on the first end of the shaft 72. The manual drive output coupler 74 may be attached to the hopper drive shaft 50 with the bolt 80.

The handle 84 is attached to the manual drive input coupler 82 and the manual drive locking system 98 is moved to the disengaged position. Thereafter, the handle 84 may be rotated to move the hopper door 12 between the open and closed positions. When done moving the hopper door 12, the manual drive locking system 98 is moved to the engaged position to prevent inadvertent movement of the hopper door 12.

In the preceding detailed description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The preceding detailed description, therefore, is not to be taken in a limiting sense, and the scope of the present invention is defined by the appended claims.

It is contemplated that features disclosed in this application, as well as those described in the above applications incorporated by reference, can be mixed and matched to suit particular circumstances. Various other modifications and changes will be apparent to those of ordinary skill.

1. A motorized hopper door actuation system for use in conjunction with a hopper vehicle having at least one hopper door for removing product therefrom, wherein the motorized hopper door actuation system comprises:
a motor operatively attached to the hopper door;
mounting means operatively attaching the motor to the hopper vehicle; and
control means operably connected to the motor.

2. The motorized hopper door actuation system of claim 1, wherein the mounting means comprises a mounting section, an arm section and a main section, wherein the arm section pivotally interconnects the mounting section and the main section, wherein the mounting section is operably attached to the hopper vehicle and wherein the motor is operably attached to the mounting means.

3. The motorized hopper door actuation system of claim 1, and further comprising a mud flap that extends over at least a portion of the motor.

4. The motorized hopper door actuation system of claim 1, and further comprising:
a motor output coupler attached to the motor; and
a hopper drive shaft attached to the hopper door, wherein the motor output coupler releasably engages the hopper drive shaft.

5. The motorized hopper door actuation system of claim 1 where the control means is operably attached to the mounting means.

6. The motorized hopper door actuation system of claim 1, wherein the motor is an electric motor.

7. The motorized hopper door actuation system of claim 6, wherein the control means is an electric switch.

8. The motorized hopper door actuation system of claim 6, wherein the control means is a remote controlled electric switch.

9. The motorized hopper door actuation system of claim 6, wherein the control means is an electric relay or solenoid.

10. The motorized hopper door actuation system of claim 1, wherein the motor is a hydraulic motor.

11. The motorized hopper door actuation system of claim 11, wherein the control means is a hydraulic valve.

12. The motorized hopper door actuation system of claim 11, wherein the control means is a remote controlled hydraulic valve.

13. A motorized hopper door actuation system for use in conjunction with a hopper vehicle having at least one hopper door for removing product therefrom, wherein the motorized hopper door actuation system comprises:
a motor;
manual drive means separate from the motor, wherein the motor and the manual drive means are capable of independently engaging the hopper door; and
mounting means operably attaching the motor and the manual drive means to the hopper vehicle.

14. The motorized hopper door actuation system of claim 13, and further comprising a control means operably connected to the motor.

15. The motorized hopper door actuation system of claim 14, wherein the control means is operably attached to the mounting means.

16. The motorized hopper door actuation system of claim 13, and further comprising a mud flap mounted to the mounting means, wherein the mud flap extends over at least a portion of at least one of the motor and the manual drive means.

17. The motorized hopper door actuation system of claim 13, and further comprising:
a motor output coupler attached to the motor;
a manual drive output coupler attached to the manual drive means; and
a hopper drive shaft attached to the hopper door, wherein the motor output coupler and the manual drive output coupler are capable of releasably engaging the hopper drive shaft.

18. The motorized hopper door actuation system of claim 13, and further comprising a manual drive locking mechanism that is capable of preventing rotation of the manual drive means.

19. The motorized hopper door actuation system of claim 13, wherein the manual drive means includes a gear reduction to allow for manual operation with reduced input torque.

20. A motorized hopper door actuation system for use in conjunction with a hopper vehicle having at least one hopper door for removing product therefrom, wherein the motorized hopper door actuation system comprises:
a hopper door mounted to the hopper vehicle;
a hopper drive shaft for controlling movement of the hopper door with respect to the hopper vehicle;
a motor operatively attached to the hopper drive shaft; and
mounting means to operatively attach the motor to the hopper vehicle, wherein the motor is detachable from the hopper drive shaft and the mounting means without detaching the hopper drive shaft from the hopper door.

21. The motorized hopper door actuation system of claim 20, and further comprising a control means operably attached to the motor.

22. The motorized hopper door actuation system of claim 21, wherein the control is operably attached to the mounting means.

23. The motorized hopper door actuation system of claim 20, and further comprising a mud flap mounted to the mounting means, wherein the mud flap extends over at least a portion of the motor.

24. The motorized hopper door actuation system of claim 20, and further comprising:
a motor output coupler attached to the motor; and
a hopper drive shaft attached to the hopper door, wherein the motor output coupler is capable of releasably engaging the hopper drive shaft.
